(19) United States
(12) Patent Application Publication
(10) Pub. No.: US 2012/0105342 A1
(43) Pub. Date: May 3, 2012

(54) Touch Panel, Display Device and Manufacturing Method of Touch Panel

(75) Inventor: Jae-Young Yu, Yongin-City (KR)

(73) Assignee: SAMSUNG MOBILE DISPLAY CO., LTD., Yongin-City (KR)

(21) Appl. No.: 13/082,877

(22) Filed: Apr. 8, 2011

(30) Foreign Application Priority Data
Oct. 29, 2010 (KR) 10-2010-0106887

(51) Int. Cl. G06F 3/041; B05D 5/12

(52) U.S. Cl. 345/173; 427/58

(57) ABSTRACT

A touch panel comprises a substrate and at least one touch pad positioned on the substrate and having an uneven surface. Each touch pad contacts the substrate, and comprises a plurality of first sub-touch pads arranged in a first direction, a first connector connecting adjacent first sub-touch pads to each other, a plurality of second sub-touch pads arranged in a second direction crossing the first direction, a second connector positioned so as to correspond to the first connector and connecting adjacent second sub-touch pads to each other, and an insulating layer positioned between the first connector and the second connector. A manufacturing method of the touch panel comprises preparing a substrate, and forming at least one touch pad on the substrate, each touch pad having an uneven surface.

### CLAIM OF PRIORITY

This application makes reference to, incorporates the same herein, and claims all benefits accruing under 35 U.S.C. §119 from an application earlier filed in the Korean Intellectual Property Office on the 29 Oct. 2010 and there duly assigned Serial No. 10-2010-0106887.

### BACKGROUND OF THE INVENTION

1. Field of the Invention

The present invention relates generally to a touch panel. More particularly, the present invention relates to a capacitive touch panel including the touch panel, a display device, and a manufacturing method of the touch panel.

2. Description of the Related Art

A touch panel us a device which recognizes a touch by a pen or a user's finger. As such, it has been disposed in a display unit of an organic light emitting diode (OLED) display or a liquid crystal display (LCD), and has been used in recent years as a means for inputting a signal into the display device.

Among touch panels, a capacitive touch panel detects an input location where the touch is performed by measuring variation in the capacitance of a touch pad corresponding to the location where the touch is performed when the touch is performed on the touch pad included in the touch panel.

However, the touch panel has a problem in that external light is reflected by the touch pad so as to deteriorate the visibility of an image displayed by the display unit.

The above information disclosed in this Background section is only for enhancement of an understanding of the background of the described technology and therefore it may contain information which does not form the prior art which is already known in this country to a person of ordinary skill in the art.

### SUMMARY OF THE INVENTION

The present invention has been developed in an effort to provide a touch panel which is capable of suppressing external light reflection, a display device including the touch panel, and a manufacturing method of the touch panel.

An exemplary embodiment provides a touch panel comprising: a substrate; and at least one touch pad positioned on the substrate and having an uneven surface.

The touch pad may contact the substrate.

The touch pad may include: a plurality of first sub-touch pads arranged in a first direction; a first connector connecting adjacent first sub-touch pads to each other; a plurality of second sub-touch pads arranged in a second direction crossing the first direction; a second connector positioned to correspond to the first connector and connecting adjacent second sub-touch pads to each other; and an insulating layer positioned between the first connector and the second connector.

At least one of the first sub-touch pad, the first connector, the second sub-touch pad, and the second connector may have an uneven surface.

The second sub-touch pad may be formed integrally with the second connector.

The first sub-touch pad and the second sub-touch pad may be positioned on the same layer so as to contact the substrate.

At least one of the first sub-touch pad, the first connector, the second sub-touch pad, and the second connector may include a light-transmissive conductive material.

The touch panel may further include a protective layer positioned on the touch pad, and a cover positioned on the protective layer.

Another exemplary embodiment provides a display device comprising: a display unit displaying an image; and a touch panel positioned on the display unit.

Yet another exemplary embodiment provides a manufacturing method of a touch panel comprising the steps of: preparing a substrate; and forming at least one touch pad having an uneven surface on the substrate.

The forming of the touch pad may be performed so that the touch pad contacts the substrate.

The forming of the touch pad may include: forming a first conductive layer on the substrate; forming a plurality of first connectors having an island arrangement or form by patterning the first conductive layer; forming an insulating layer on the first connector so as to expose both ends of the first connector; forming a second conductive layer on the substrate, the first connector, and the insulating layer; and forming a plurality of first sub-touch pads arranged in a first direction and each connected to one end of the first connector by patterning the second conductive layer, a plurality of second sub-touch pads arranged in a second direction crossing the first direction, and a second connector positioned on the insulating layer so as to correspond to the first connector and connecting the adjacent second sub-touch pads to each other.

At least one of the forming of the first connector and the forming of the first sub-touch pad, the second sub-touch pad, and the second connector may be performed by using a photolithography process using at least one of a half tone mask and a slit mask.

At least one of the first conductive layer and the second conductive layer may include a light-transmissive conductive material.

The method may further include: forming a protective layer on the touch pad; and forming a cover on the protective layer.

According to exemplary embodiments, there are provided a touch panel suppressing external light reflection, a display device including the touch panel, and a manufacturing method of the touch panel.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a perspective view showing a display device according to a first exemplary embodiment of the invention.

FIG. 2 is a diagram schematically showing a touch panel included in a display device according to the first exemplary embodiment of the invention.

FIG. 3 is a partial plan view illustrating a touch panel included in a display device according to the first exemplary embodiment of the invention.

FIG. 4 is a cross-sectional view taken along line IV-IV of FIG. 3.

FIG. 5 is a flowchart illustrating a manufacturing method of a touch panel according to a second exemplary embodiment of the invention.

FIGS. 6 thru 15 are diagrams for describing a manufacturing method of a touch panel according to the second exemplary embodiment of the invention.

### DETAILED DESCRIPTION OF THE INVENTION

The present invention will be described more fully hereinafter with reference to the accompanying drawings, in which exemplary embodiments of the invention are shown. As those skilled in the art will realize, the described embodiments may be modified in various different ways, all without departing from the spirit or scope of the present invention.

The drawings and description are to be regarded as illustrative in nature and not restrictive. Like reference numerals designate like elements throughout the specification.

In addition, the size and thickness of each component shown in the drawings are arbitrarily shown for understanding and ease of description, but the present invention is not limited thereto.

In the drawings, the thickness of layers, films, panels, regions, etc. are exaggerated for clarity. In the drawings, for understanding and ease of description, the thicknesses of some layers and areas are exaggerated. It will be understood that, when an element such as a layer, film, region, or substrate is referred to as being “on” another element, it can be directly on the other element or intervening elements may also be present.

In addition, unless explicitly described to the contrary, the word “comprise” and variations such as “comprises” or “comprising” will be understood to imply the inclusion of stated elements but not the exclusion of any other elements. Furthermore, in the specification, “on” implies being positioned above or below a target element, and does not imply being necessarily positioned on the top on the basis of a gravity direction.

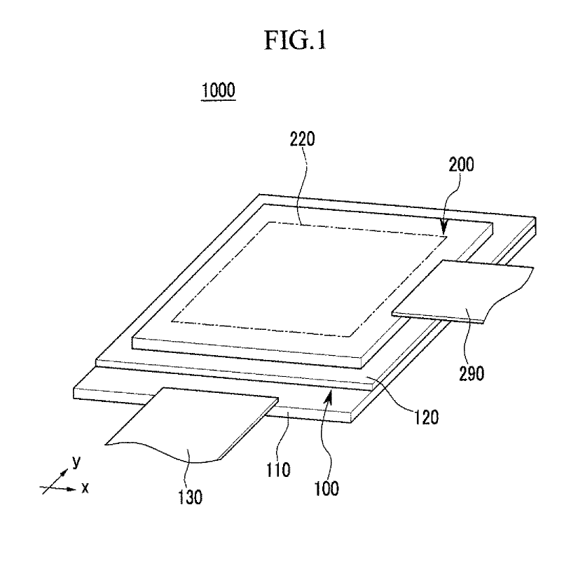

Hereinafter, a display device according to a first exemplary embodiment will be described with reference to FIGS. 1 thru 4.

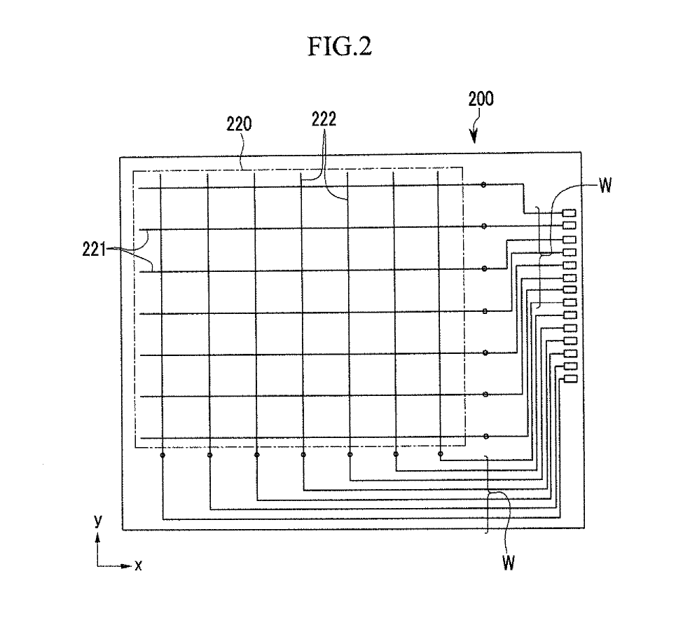

FIG. 1 is a perspective view showing a display device according to a first exemplary embodiment of the invention, and FIG. 2 is a diagram schematically showing a touch panel included in a display device according to the first exemplary embodiment of the invention.

As shown in FIGS. 1 and 2, the display device 1000 according to the first exemplary embodiment comprises display unit 100 including a plurality of pixels in a display area for displaying an image, and a touch panel 200 positioned on the display unit 100 so as to serve as an input means for the display unit 100. Herein, the pixel represents a minimum unit capable of implementing the image.

The display unit 100 includes a first display substrate 110 wherein an organic light emitting diode is formed, and a second display substrate 120 attached to the first display substrate 110. The first display substrate 110 is larger than the second display substrate 120 so as to protrude, and a first flexible printed circuit (FPC) 130 is electrically connected to the protruding part. Pad electrodes for transferring electrical signals to a scan driver and a data driver may be formed in the first flexible printed circuit (FPC) 130.

The display unit 100 according to the first exemplary embodiment may be an organic light emitting diode (OLED) display including an organic light emitting diode, but a display unit according to another exemplary embodiment may be a display device such as a liquid crystal display (LCD) or a plasma display panel (PDP).

The touch panel 200 may include a touch controller and an actuation driver which are not shown. The touch controller may calculate positional information relative to where a user touches by digitizing an electrical analog signal, transmitted from the touch panel 200, into a digital signal through a converter. The actuation driver is associated with an image controller (not shown) of the display unit 100 so as to move or select a pointer on a screen according to a coordinate signal inputted from the touch controller of the touch pad 220.

The touch panel 200 is a capacitive touch panel and a second flexible printed circuit (FPC) 290 is connected to one portion of the touch panel 200. A driving circuit (not shown) for detecting an input location on the touch panel 200 may be connected to the second flexible printed circuit (FPC) 290. A touch pad 220 for recognizing a touch is formed on the touch panel 200.

Referring to FIG. 2, the touch pad 220 includes a plurality of first sub-touch pads 221 arranged in a first direction (an x-axis direction) and a plurality of second sub-touch pads 222 arranged in a second direction (a y-axis direction) crossing the first direction.

In the first exemplary embodiment, the first sub-touch pad 221 and the second sub-touch pad 222 are perpendicular to each other with a stripe pattern, but in another exemplary embodiment, the first sub-touch pad and the second sub-touch pad may cross each other at a predetermined crossing angle.

Each of the first sub-touch pad 221 and the second sub-touch pad 22 is connected to the second flexible printed circuit (FPC) 290 through a wire W.

In the touch panel 200 configured as above, voltages are sequentially applied to the plurality of first sub-touch pads 221 and the second sub-touch pads 222 so as to provide electric charges to each of the first sub-touch pad 221 and the second sub-touch pad 222. At this time, when a touch is performed on the first sub-touch pad 221 or the second sub-touch pad 222, the capacitance of the first sub-touch pad 221 or the second sub-touch pad 222, where the touch is performed, varies so as to enable recognition of the touch location.

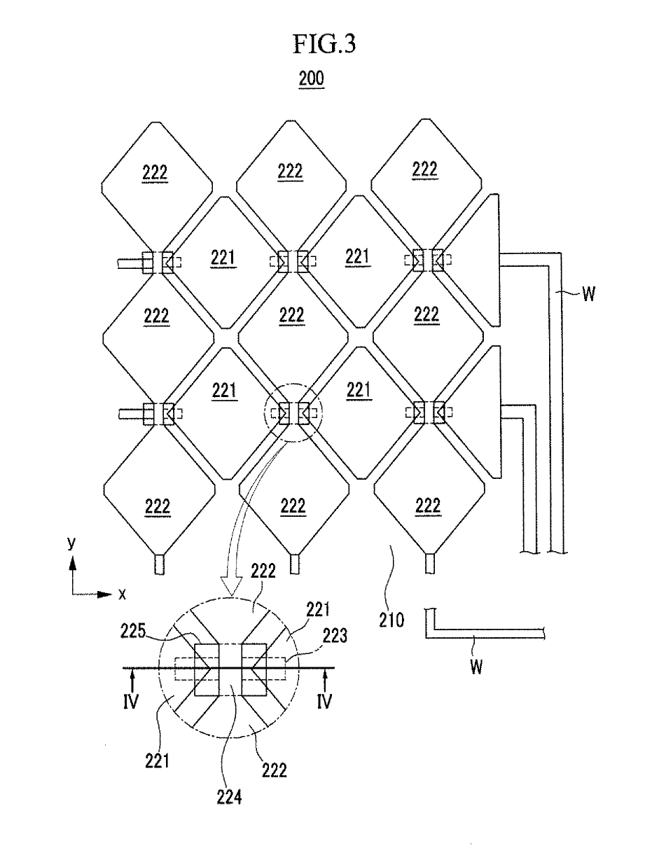

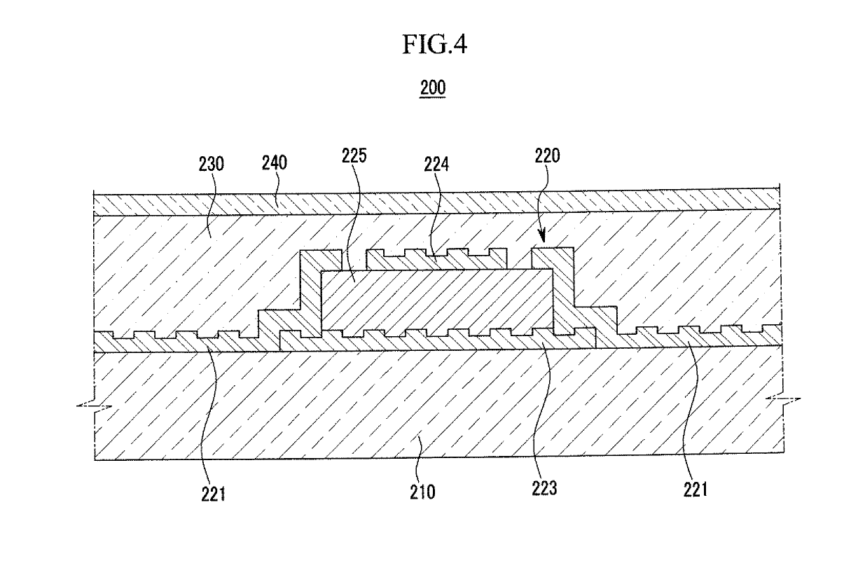

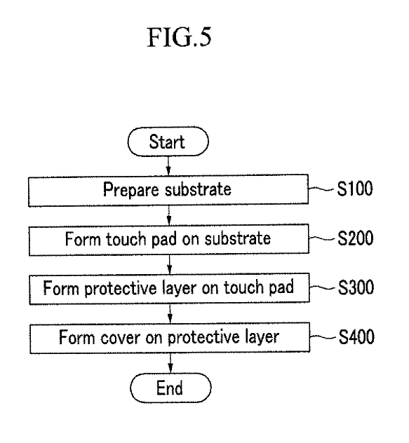

Hereinafter, referring to FIGS. 3 and 4, the touch panel 200 included in the display device 1000 according to the first exemplary embodiment will be described in more detail.

FIG. 3 is a partial plan view illustrating a touch panel included in a display device according to a first exemplary embodiment of the invention, and FIG. 4 is a cross-sectional view taken along line IV-IV of FIG. 3.

As shown in FIGS. 3 and 4, the touch panel 200 includes a substrate 210, a touch pad 220, a protective layer 230, and a cover 240.

The substrate 210 is a light-transmissive insulating substrate made of glass, quartz, ceramics, or polymer, and may have flexibility.

The touch pad 220 for recognizing a touch is formed on the substrate 210.

The touch pad 220 includes a first sub-touch pad 221, a first connector 223, a second sub-touch pad 222, a second connector 224, and an insulating layer 225.

The first sub-touch pad 221 includes a light-transmissive conductive material such as indium tin oxide (ITO) or indium zinc oxide, and the plurality of first sub-touch pads are arranged in the first direction as described above. The first sub-touch pad 221 contacts the substrate 210 and has an uneven surface. The plurality of first sub-touch pads 221 are spaced apart from each other, and the first connector 223 is positioned between adjacent first sub-touch pads 221.

The first connector 223 is positioned between the adjacent first sub-touch pads 221 in an island arrangement or form, and connects the adjacent first sub-touch pads 221 to each other. In detail, the ends of the adjacent first sub-touch pads 221 overlap each other on both ends of the first connector 223 so as to allow the first connector 223 to connect the adjacent first sub-touch pads 221. The first connector 223 contacts the substrate 210 and has an uneven surface. The first connector 223 includes a light-transmissive conductive material such as indium tin oxide or indium zinc oxide.

The second sub-touch pad 222 includes a light-transmissive conductive material such as indium tin oxide or indium zinc oxide, and the plurality of second sub-touch pads 222 are arranged in the second direction crossing the first direction as described above. Each second sub-touch pad 222 is positioned on the same layer as a first sub-touch pad 221 so as to contact the substrate 210, and has an uneven surface. The plurality of second sub-touch pads 222 are spaced apart from each other, and the second connector is positioned between the adjacent second sub-touch pads 222.

The second connector 224 is positioned between the adjacent second sub-touch pads 222, and is formed integrally with the second sub-touch pad 222. The second connector 224 is positioned on the first connector 223 with the insulating layer 225 interposed therebetween. That is, the second connector 224 is insulated from the first connector 223 so as to connect the adjacent second sub-touch pads 222 to each other, and is spaced apart from the first sub-touch pad 221. In detail, the second connector 224 is formed integrally with the second sub-touch pad 222 so as to allow the second connector 224 to connect adjacent second sub-touch pads 222 to each other. The first connector 224 is positioned on the insulating layer 225 so as to be spaced apart from the substrate 210, and has an uneven surface. The second connector 224 includes the light-transmissive conductive material such as indium tin oxide or indium zinc oxide.

The insulating layer 225 is positioned in the island arrangement or form between the first connector 223 and the second connector 224 so as to correspond to the first connector 223 and the second connector 224. The insulating layer 225 is positioned between the first connector 223 and the second connector 224 so as to insulate the first connector 223 and the second connector 224 from each other.

As described above, the touch pad 220 includes the first sub-touch pad 221, the first connector 223, the second sub-touch pad 222, and the second connector 224, each of which has an uneven surface, such that external light inputted into the touch panel 200 is scattered by the uneven surface, and as a result, external light reflection by the touch pad 220 is suppressed.

In the touch pad 220 of the touch panel 200 of the display device 1000 according to the first exemplary embodiment, each of the first sub-touch pad 221, the first connector 223, the second sub-touch pad 222, and the second connector 224 has an uneven surface, but in a touch pad according to another exemplary embodiment, only at least one of a first sub-touch pad, a first connector, a second sub-touch pad, and a second connector has the uneven surface.

The protective layer 230 is positioned on the touch pad 220.

The protective layer 230 covers the touch pad 220 and prevents the touch pad 220 from being damaged by interference, such as pressure applied from the outside. A cover 240 is positioned on the protective layer 230.

The cover 240 is positioned on the protective layer 230 in the form of a substrate or a thin film, and prevents the touch pad 220 from being damaged by interference, such as pressure applied from the outside, together with the protective layer 230. The touch may be performed directly on the surface of the cover 240.

As such, in the display device 1000 according to the first exemplary embodiment, the touch pad 220 of the touch panel 200 has an uneven surface so as to suppress external light reflection from the touch panel 200, thereby suppressing visibility of an image displayed by the display unit 100 from being deteriorated by external light reflection from the touch panel 200. In particular, even though the display device 1000 according to the first exemplary embodiment is exposed to an environment in which sunlight is directly irradiated, external light reflection by the touch panel 200 is suppressed, thereby preventing the visibility of the image displayed by the display device 1000 from being deteriorated.

Furthermore, in the display device 1000 according to the first exemplary embodiment, the touch pad 220 recognizing the touch is in contact with the substrate 210 so that no material is positioned between the touch pad 220 and the substrate 210. In more detail, no material is positioned between the first sub-touch pad 221 and the substrate 210 and between the second sub-touch pad 222 and the substrate 210, so as to prevent luminance from being deteriorated when the image displayed by the display unit 100 passes through the touch panel 200.

As described above, the display device 1000 according to the first exemplary embodiment improves display quality by preventing deterioration in visibility and luminance of the image displayed by the display unit 100.

Hereinafter, referring to FIGS. 5 thru 15, a manufacturing method of a touch panel according to a second exemplary embodiment will be described.

The manufacturing method of the touch panel according to the second exemplary embodiment is a method of manufacturing the touch panel 200 of the display device 1000 according to the first exemplary embodiment, but the touch panel 200 of the display device 1000 according to the first exemplary embodiment is not limited thereto, and may be manufactured by various methods.

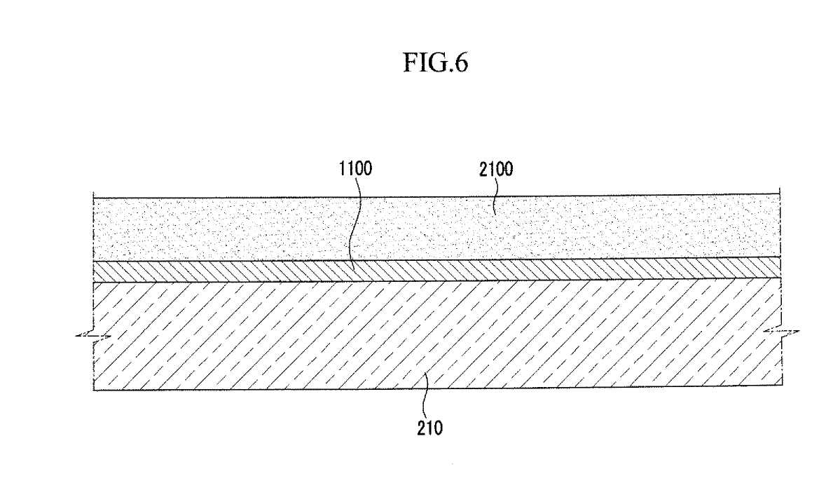

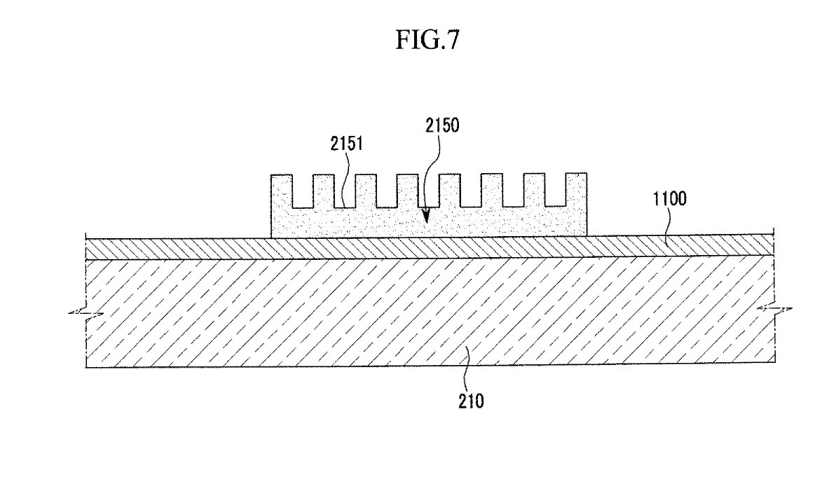

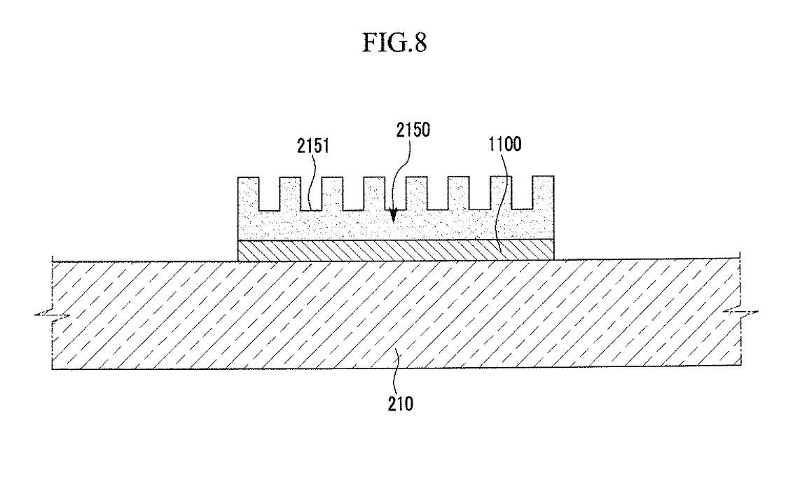

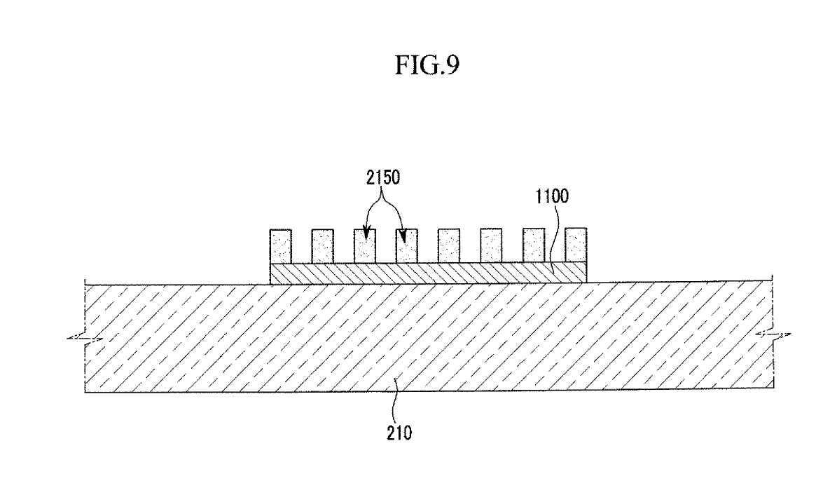

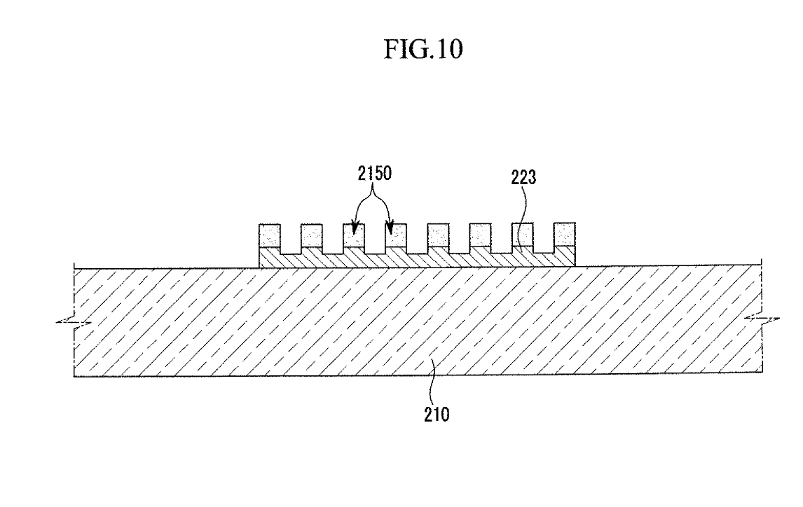

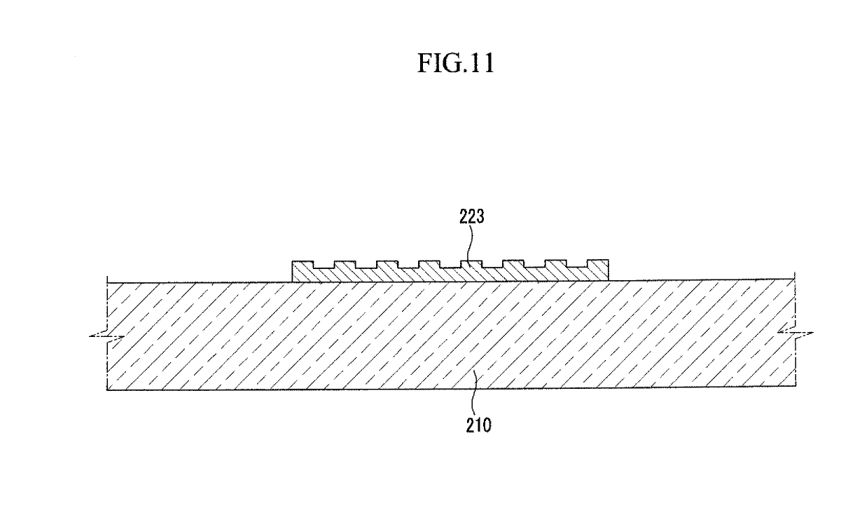

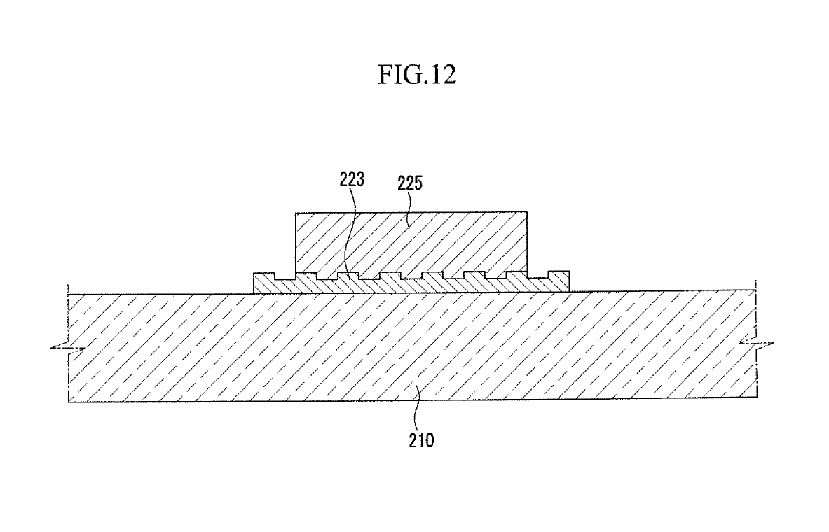

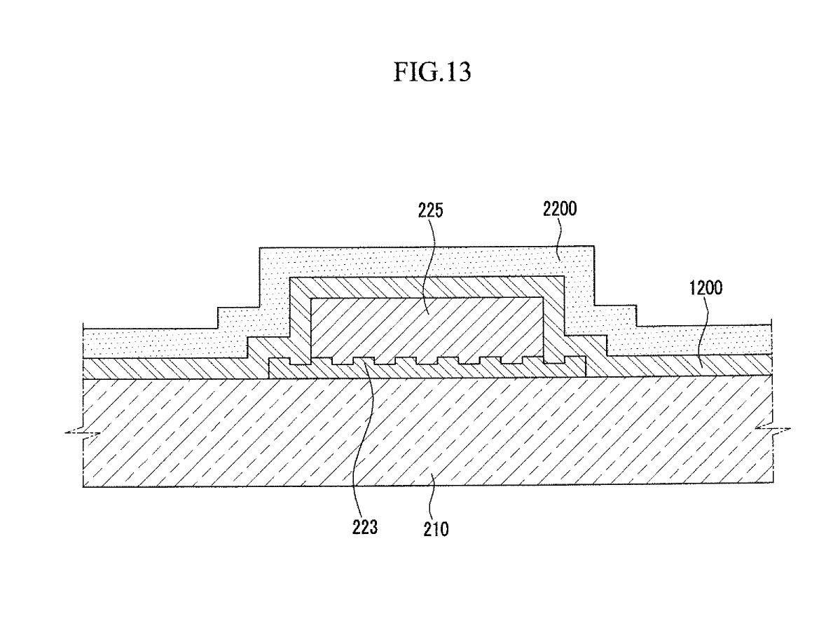

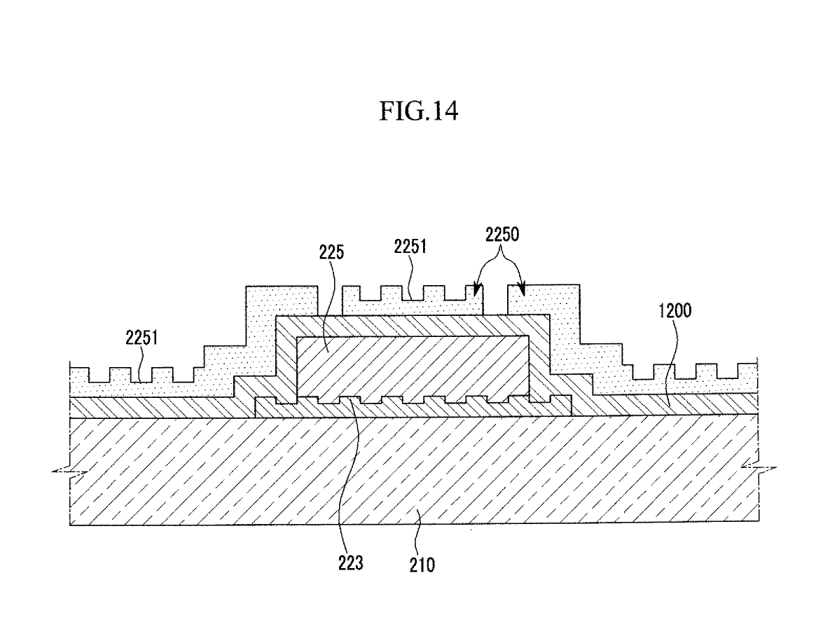

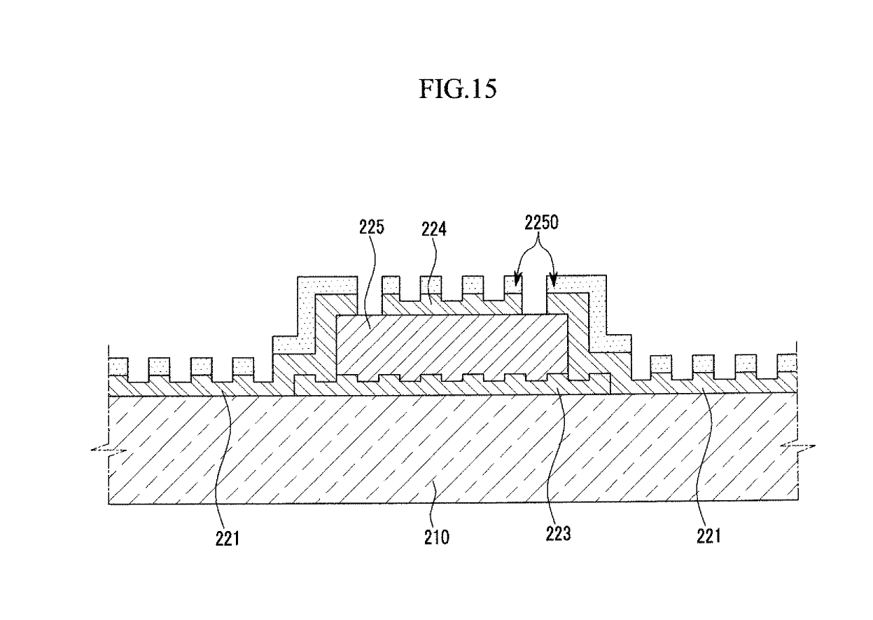

FIG. 5 is a flowchart illustrating a manufacturing method of a touch panel according to a second exemplary embodiment of the invention, and FIGS. 6 thru 15 are diagrams for describing a manufacturing method of a touch panel according to a second exemplary embodiment of the invention.

First, as shown in FIGS. 5 and 6, a substrate 210 is prepared (S100).

Next, a touch pad 220 is formed on the substrate 210 (S200).

Hereinafter, forming the touch pad 220 on the substrate 210 will be described.

First, a first conductive layer 1100 is formed on the substrate 210.

In detail, the first conductive layer 1100 includes a light-transmissive conductive material, such as indium tin oxide or indium zinc oxide, and is formed on the substrate 210 by using a physical or chemical deposition process.

Next, a plurality of first connectors 223 having an island form are formed by patterning the first conductive layer 1100.

Hereinafter, a process of forming the first connector 223 will be described in detail.

First, a first photoresist layer 2100 is formed on the first conductive layer 1100, a half tone mask is disposed on the first photoresist layer 2100, and the first photoresist layer 2100 is exposed and developed through the half tone mask so as to form a first photoresist pattern 2150 having an uneven surface corresponding to the first connector 223, to be formed below as shown in FIG. 7. In this case, the half tone mask includes a light transmitting region, a light blocking region, and a light semi-transmitting region. The light blocking region of the half ton mask corresponds to the entirety of the first photoresist pattern 2150 to be formed from the first photoresist layer 2100, and the light semi-transmitting region corresponds to a concave part 2151 on the uneven surface of the first photoresist pattern 2150.

Meanwhile, the manufacturing method of the touch panel according the second exemplary embodiment uses the halftone mask, but a manufacturing method of a touch panel according to another exemplary embodiment may use at least one of the half tone mask and a slit mask.

Next, as shown in FIG. 8, a part of the first conductive layer 1100 which is exposed while not corresponding to the first photoresist pattern 2150 is removed from the substrate 210 by wet-etching the first conductive layer 1100 by using the first photoresist pattern 2150 as a mask.

Next, as shown in FIG. 9, the first conductive layer 1100 corresponding to the concave part 2151 of FIG. 8 is exposed by fully removing the concave part 2151 of the first photoresist pattern 2150 by using an ashing process.

Next, as shown in FIG. 10, the first connector 223, having an uneven surface, is formed by dry-etching the exposed first conductive layer 1100.

Subsequently, as shown in FIG. 11, the first photoresist pattern 2150 of FIG. 10, positioned on the first connector 223, is removed from the first connector 223.

The first connector 223 of FIG. 11 is formed on the substrate 210 by a photolithography process using at least one of the half tone mask and the slit mask.

Meanwhile, in the manufacturing method of the touch panel according to the second exemplary embodiment, the first photoresist pattern 2150 is formed on the first conductive layer 1100, and thereafter the first connector 223 is formed using wet etching, an ashing process and dry etching, but in a manufacturing method of a touch panel according to another exemplary embodiment, the first photoresist pattern 2150 is formed on the first conductive layer 1100, and thereafter the first connector 223 may be formed by dry-etching both the first photoresist pattern 2150 and the first conductive layer 1100 at once. In this case, the first conductive layer 1100 is etched in the same form as the first photoresist pattern 2150 while the first photoresist pattern 2150 is etched by dry etching so as to form the first connector 223 from the first conductive layer 1100.

Next, as shown in FIG. 12, an insulating layer 225 is formed on the first connector 223. In detail, the insulating layer 225 having an island form or structure is formed on the first connector 223 so as to expose both ends of the first connector 223.

Next, as shown in FIG. 13, a second conductive layer 1200 is formed on the substrate 210, the first connector 223 and the insulating layer 225. In detail, the second conductive layer 1200, including a light-transmissive conductive material such as indium tin oxide or indium zinc oxide, is formed on the substrate 210, the first connector 223 and the insulating layer 225 by using a physical or chemical deposition process.

Next, a first sub-touch pad 221, a second sub-touch pad 222, and a second connector 224 are formed by patterning the second conductive layer 1200.

Hereinafter, a process of forming the first sub-touch pad 221, the second sub-touch pad 222, and the second connector 224 will be described in detail.

First, a second photoresist layer 2200 is formed on the second conductive layer 1200 (see FIG. 13), a half tone mask is disposed on the second photoresist layer 2200, and the second photoresist layer 2200 is exposed and developed through the half tone mask so as to form a second photoresist pattern 2250 having an uneven surface corresponding to the first sub-touch pad 221, the second sub-touch pad 222, and the second connector 224 to be formed below, as shown in FIG. 14. In this case, the half tone mask includes a light transmitting region, a light blocking region, and a light semi-transmitting region. The light blocking region of the half tone mask corresponds to the entirety of the second photoresist pattern 2250 to be formed from the second photoresist layer 2200, and the light semi-transmitting region corresponds to a concave part 2251 on the uneven surface of the second photoresist pattern 2250.

Next, as shown in FIG. 15, a part of the second conductive layer 1200, which is exposed while not corresponding to the second photoresist pattern 2250, is removed from the substrate 210 by wet-etching the second conductive layer 1200 by using the second photoresist pattern 2250 as a mask. The concave part 2251 of the second photoresist pattern 2250 is fully removed by use of the ashing process so as to expose the second conductive layer 1200 corresponding to the concave part 2251, and the first sub-touch pad 221, the second sub-touch pad 222, and the second connector 224 having the uneven surfaces are formed by dry-etching the exposed second conductive layer 1200.

Next, the second photoresist pattern 2250, positioned on the first sub-touch pad 221, the second sub-touch pad 222 and the second connector 224, is removed from the first sub-touch pad 221, the second sub-touch pad 222 and the second connector 224.

The first sub-touch pad 221, the second sub-touch pad 222 and the second connector 224 are formed on the substrate 210 by using a photolithography process by use of at least one of the half tone mask and the slit mask.

Meanwhile, in the manufacturing method of the touch panel according to the second exemplary embodiment, the second photoresist pattern 2250 is formed on the second conductive layer 120, and thereafter the first sub-touch pad 221, the second sub-touch pad 222 and the second connector 224 are formed using wet etching, an ashing process and dry etching. However, in a manufacturing method of a touch panel according to another exemplary embodiment, the second photoresist pattern 2250 is formed on the second conductive layer 1200, and thereafter the first sub-touch pad 221, the second sub-touch pad 222 and the second connector 224 may be formed by dry-etching both the second photoresist pattern 2250 and the second conductive layer 1200 at the same time. In this case, the second conductive layer 1200 is etched in the same form as the second photoresist pattern 2250 while the second photoresist pattern 2250 is etched by dry etching so as to form the first sub-touch pad 221, the second sub-touch pad 222, and the second connector 224 from the second conductive layer 1200.

By such a process, the touch pad 220, including the first connector 223, the insulating layer 225, the first sub-touch pad 221, the second sub-touch pad 222 and the second connector 224, is formed on the substrate 210 while being in contact with the substrate 210.

Next, referring to FIG. 5, a protective layer 230 is formed on the touch pad 220 (S300).

In detail, the protective layer 230 is formed on the touch pad 220 by applying or depositing the protective layer 230 on the substrate 210 on which the touch pad 220 is formed.

Next, a cover 240 is formed on the protective layer 230 (S400).

In detail, the cover 240 is formed on the protective layer 240 by attaching the cover 240, in the form of a substrate or a thin film, onto the protective layer 230.

By such a process, the touch panel 200 of the display device 1000 according to the first exemplary embodiment is manufactured.

As described, in the manufacturing method of the touch panel according to the second exemplary embodiment, since the first connector 223, the first sub-touch pad 221, the second sub-touch pad 222 and the second connector 224, which may have the uneven surfaces, are formed on the substrate 210 through a photolithography process using at least one of the half tone mask and the slit mask. The surface of at least one of the first connector 223, the first sub-touch pad 221, the second sub-touch pad 222 and the second connector 224 may have an uneven form even though there is no material between the substrate 210 and the touch pad 220. That is, an uneven structure does not need to be formed between the substrate 210 and the touch pad 220 in order to form the surface of at least one of the first connector 223, the first sub-touch pad 221, the second sub-touch pad 222 and the second connector 224 having an uneven form, causing deterioration of luminance by the touch panel 200 to be suppressed.

While the invention has been described in connection with what is presently considered to be practical exemplary embodiments, it is to be understood that the invention is not limited to the disclosed embodiments but, on the contrary, is intended to cover various modifications and equivalent arrangements included within the spirit and scope of the appended claims.

What is claimed is:

1. A touch panel, comprising:
a substrate; and
at least one touch pad positioned on the substrate and having an uneven surface.

2. The touch panel of claim 1, wherein the touch pad contacts the substrate.

3. The touch panel of claim 1, wherein the touch pad comprises:
a plurality of first sub-touch pads arranged in a first direction;
a first connector connecting adjacent first sub-touch pads to each other;
a plurality of second sub-touch pads arranged in a second direction crossing the first direction;
a second connector positioned so as to correspond to the first connector and connecting adjacent second sub-touch pads to each other; and
an insulating layer positioned between the first connector and the second connector.

4. The touch panel of claim 3, wherein at least one of the first sub-touch pad, the first connector, the second sub-touch pad and the second connector has an uneven surface.

5. The touch panel of claim 3, wherein the second sub-touch pad is formed integrally with the second connector.

6. The touch panel of claim 3, wherein the first sub-touch pad and the second sub-touch pad are positioned on a same layer so as to contact the substrate.

7. The touch panel of claim 3, wherein at least one of the first sub-touch pad, the first connector, the second sub-touch pad and the second connector includes a light-transmissive conductive material.

8. The touch panel of claim 1, further comprising:
a protective layer positioned on the touch pad; and
a cover positioned on the protective layer.

9. A display device, comprising a display unit for displaying an image, and a touch panel as recited in claim 8, said touch panel being positioned on the display unit.

10. A display device, comprising a display unit for displaying an image, and a touch panel as recited in claim 3, said touch panel being positioned on the display unit.

11. A display device, comprising a display unit for displaying an image, and a touch panel as recited in claim 1, said touch panel being positioned on the display unit.

12. A manufacturing method of a touch panel, comprising the steps of:
preparing a substrate; and
forming at least one touch pad having an uneven surface on the substrate.

13. The method of claim 12, wherein the step of forming said at least one touch pad is performed so that the touch pad contacts the substrate.

14. The method of claim 12, wherein the step of forming said at least one touch pad includes:
forming a first conductive layer on the substrate;
forming a plurality of first connectors having an island form by patterning the first conductive layer;
forming an insulating layer on the first connectors so as to expose both ends of the first connectors;
forming a second conductive layer on the substrate, the first connectors, and the insulating layer;
forming a plurality of first sub-touch pads arranged in a first direction, each first sub-touch pad being connected to one end of the first connectors by patterning the second conductive layer;
forming a plurality of second sub-touch pads arranged in a second direction crossing the first direction; and
forming a second connector positioned on the insulating layer so as to correspond to the first connector, and connecting adjacent second sub-touch pads to each other.

15. The method of claim 14, wherein at least one of the steps of forming the plurality of first connectors, forming the plurality of first sub-touch pads, forming the plurality of second sub-touch pads, and forming the second connector is performed by using a photolithography process using at least one of a half tone mask and a slit mask.

16. The method of claim 14, wherein at least one of the first conductive layer and the second conductive layer includes a light-transmissive conductive material.

17. The method of claim 12, further comprising the steps of:
forming a protective layer on said at least one touch pad; and
forming a cover on the protective layer.
